(19) United States
(12) Patent Application Publication
(10) Pub. No.: US 2004/0044913 A1
(43) Pub. Date: Mar. 4, 2004

(54) Method for coordinating built-in bluetooth modules

(76) Inventor: Kuang Ming Wu, Hsin-Tien City (TW)

Correspondence Address: BIRCH STEWART KOLASCH & BIRCH, PO BOX 747, FALLS CHURCH, VA, 22040-0747, US

(21) Appl. No.: 10/230,316

(22) Filed: Aug. 29, 2002

(51) Int. Cl. H04L 9/32

(52) U.S. Cl. 713/202

(57) ABSTRACT

A method for coordinating built-in bluetooth modules mainly establishes a coordinating program in a bluetooth keyboard module to coordinate a HUB, a wireless keyboard control equation and process procedures of a host controller interface (HCI) resided in the bluetooth keyboard module. The coordinating program enables the wireless keyboard control equation to generate a simulated keyboard signal to enable a conventional keyboard to start operation smoothly. Meanwhile, the coordinating program coordinates the wireless keyboard control equation and the HCI process procedures to enable future operating systems equipped with a bluetooth driver program to directly use the receiving end of the bluetooth keyboard to form a standardized specification.

### FIELD OF THE INVENTION

The present invention relates to a method for coordinating built-in bluetooth modules and particularly a method that establishes a coordinating program in a bluetooth keyboard module to coordinate a wireless keyboard control equation and processing procedures of a host controller interface (HCI) and to be compatible with conventional computer keyboard functions.

### BACKGROUND OF THE INVENTION

In existing standard bluetooth modules such as the one shown in FIG. 1, there are three designated electric interface standards, i.e. RS-232, UART and USB. The application interface of the protocol between the bluetooth module and the application processor is done through a host controller interface (HCI). As the present bluetooth standards do not provide keyboard function, the bluetooth module is directly inserted into a USB slot of the host end of the personal computer. The bluetooth USB does not include USB Human Interface Device (HID) keyboard functions, hence the BIOS resided in the personal computer cannot directly use the bluetooth module.

Therefore at present there is no standard specification in terms of bluethooth wireless keyboard applications. Most adopt and extend existing standards, such as employing the standard Cable Replacement Protocol (RFCOMM) and HID keyboard standards specified in the USB standards, and including an embedded microprocessor for controlling. In such an architecture the bluetooth module merely functions as a wireless data transmission medium. In the event of operating system upgrade in the future, the HCI portion cannot be directly controlled, as it is already intercepted by the microprocessor located at the receiving end of the keyboard that controls the communication with the USB of the personal computer.

### SUMMARY OF THE INVENTION

Therefore the primary object of the invention is to resolve the aforesaid disadvantages incurred to conventional bluetooth module applications. The invention provides a built-in coordinating program in the bluetooth keyboard module to enable the wireless bluetooth keyboard module compatible with conventional computer keyboard function, and can be started for use whenever there is a USB supported by BIOS.

Another object of the invention is to enable the bluetooth module at the receiving end of the bluetooth keyboard to become a standardized specification for future operating systems that equip with a bluetooth driver program so that to purchase an additional bluetooth module is not necessary.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a block diagram of a standard bluetooth module of the invention.

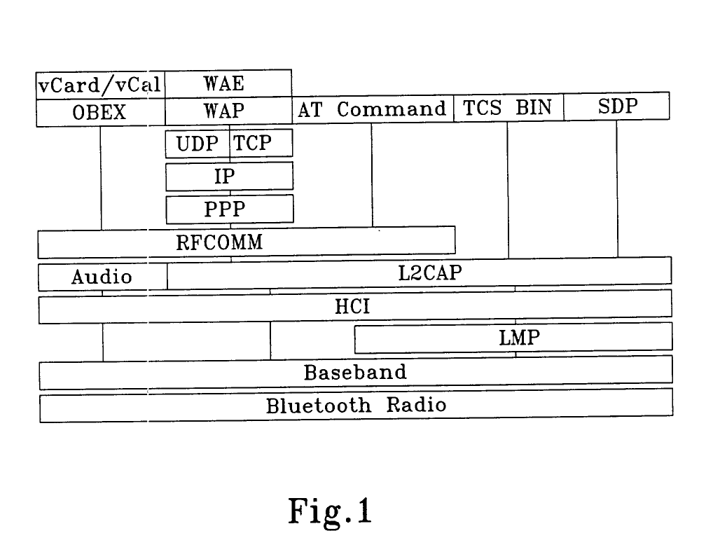

FIG. 2 is a system block diagram of the bluetooth module of the invention.

FIG. 3 is a process flow chart of the coordinating procedure of the bluetooth module and bluetooth protocol process according to the invention.

FIG. 4 is a system block diagram of another embodiment of the invention.

FIG. 5 is a system block diagram of yet another embodiment of the invention

### DESCRIPTION OF THE PREFERRED EMBODIMENTS

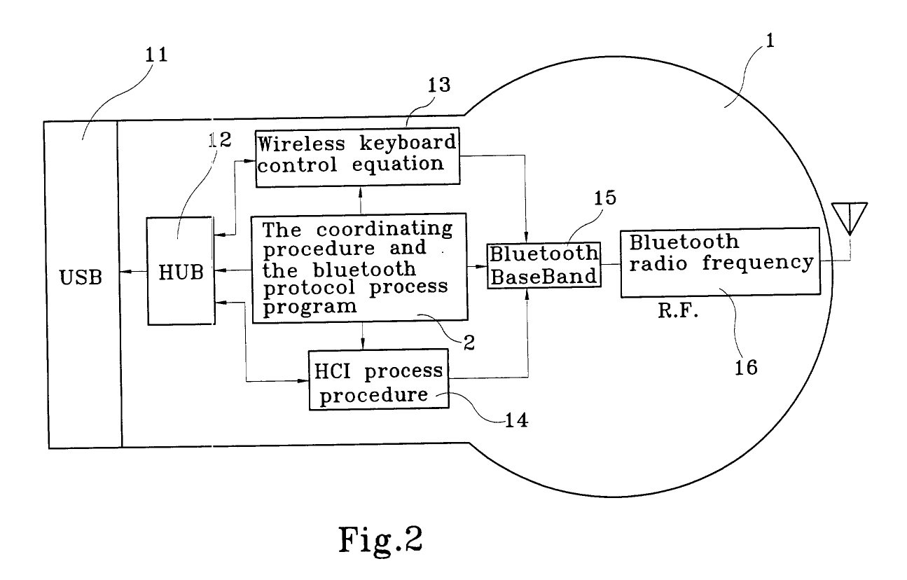

Refer to FIG. 2 for the system block diagram of the bluetooth module of the invention. The method of the invention mainly includes adding a coordinating procedure and a bluetooth protocol process program 2 in a bluetooth keyboard 1 to form a wireless keyboard of a wireless bluetooth module that has overlapped functions.

The bluetooth keyboard module 1 includes a USB 11, a HUB 12, a wireless keyboard control equation 13, a host controller interface (HCI) process procedure 14, a bluetooth base band 15 and a bluetooth radio frequency (RF) 16. The HUB 12, wireless keyboard control equation 13, HCI process procedure 14, and bluetooth base band 15 are linked to the coordinating procedure and bluetooth protocol process program 2 for coordinating the wireless keyboard and the HCI.

The coordinating procedure and bluetooth protocol process program 2 is loaded into the bluetooth keyboard module 1. A conventional compute is connected to the bluetooth keyboard module 1, and generates (or simulates) a keyboard signal through the coordinating procedure and bluetooth protocol process program 2. The keyboard signal is detected by the BIOS of the conventional computer and confirmed that the keyboard has been connected to the bluetooth keyboard module 1, then the computer is started for operation. Hence the wireless bluetooth keyboard module not only is totally compatible with the keyboard functions of previous computers (such as desk top computers) without the need of operating system upgrade, it also can function as long as there is a USB 1 supported by BIOS. The bluetooth module at the receiving end of the bluetooth keyboard may also be directly used and form a standardized specification for future operating systems that equip with a bluetooth driver program without the need to buy an additional bluetooth module.

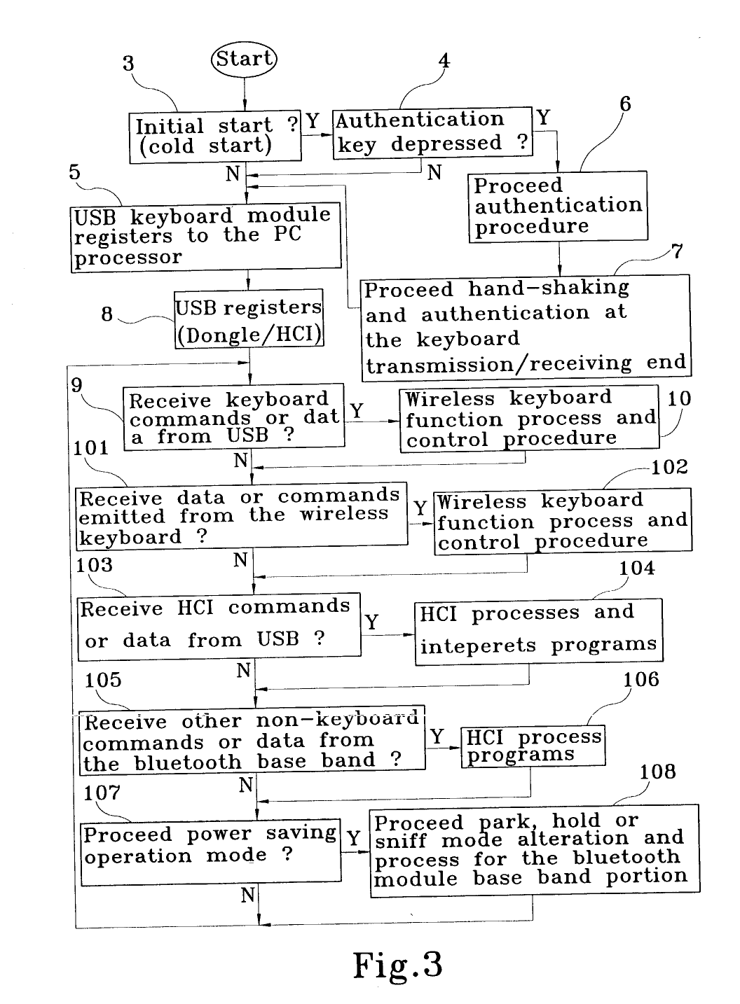

Refer to FIG. 3 for the process flow chart of the coordinating procedure of the bluetooth module and bluetooth protocol process according to the invention. As shown in the drawing, the coordinating procedure and bluetooth protocol process program 2 is loaded into the bluetooth keyboard module 1. When in use, the program performs authentication process (identifying passwords). At the initial time of the authentication process, users may enter a serial number (password) or a self-setting password on the keyboard to make registration to the computer. The password will be verified and authenticated every time the user trying to use the computer. Access to the computer will be denied when the entering password is incorrect.

When the coordinating procedure and bluetooth protocol process program 2 coordinates the process, first, determine whether the process is the initial operation (cold start) 3; if positive (i.e. initial operation), determine whether the authentication key 4 is depressed; if the authentication key 4 is not depressed, enter the USB keyboard module and register to the PC processor 5 if the authentication key 4 is depressed, proceed the authentication process 6 and the keyboard transmission and receiving end processes hand-shaking and authentication 7, and register the USB keyboard module to the PC processor 5; if it is not the initial operation, directly register the USB keyboard module to the PC processor 5 and proceed USB Dongle/HCI 8 process; after the USB Dongle/HCI 8 process, determine whether having received keyboard commands or data 9 from the USB; if negative (i.e. not receiving keyboard commands or data from the USB), determine whether having received data or commands emitted from the wireless keyboard 101; if the received keyboard commands or data 9 is from the USB, enter into a wireless keyboard process and control procedure 10, then determine whether having received data or commands emitted from the wireless keyboard 101; if negative (i.e. not receiving data or commands emitted from the wireless keyboard 101), determine whether having received bluetooth module HCI commands or data from the USB 103; if positive (i.e. having received data or commands emitted from the wireless keyboard 101), proceed a wireless keyboard function process and control procedure 102, then determine whether having received bluetooth module HCI commands or data from the USB 103; if negative (i.e. not receiving bluetooth module HCI commands or data from the USB 103), determine whether having received other non-keyboard commands or data from the bluetooth base band 105; if positive (i.e. having received bluetooth module HCI commands or data from the USB 103), proceed bluetooth module HCI process and interpretation program 104, then determine whether having received other non-keyboard commands or data from the bluetooth base band 105; if negative (i.e. not receiving other non-keyboard commands or data from the bluetooth base band 105), determine whether to proceed the power saving operation mode 107; if positive (having received other non-keyboard commands or data from the bluetooth base band 105), proceed the bluetooth HCI process program 106, then determine whether to proceed the power saving operation mode 107; if negative (i.e. not to proceed the power saving operation mode 107), go back to the step 9 to repeat the process of determining whether having received keyboard commands or data. If the power saving operation is determined to be performed, proceed park, hold or sniff mode alteration and process for the bluetooth module base band portion 108, then go back to the step 9 to repeat the process of determining whether having received keyboard commands or data. If no data or commands are received at the step 9, 101, 103 or 105, the system directly enters into a standby state.

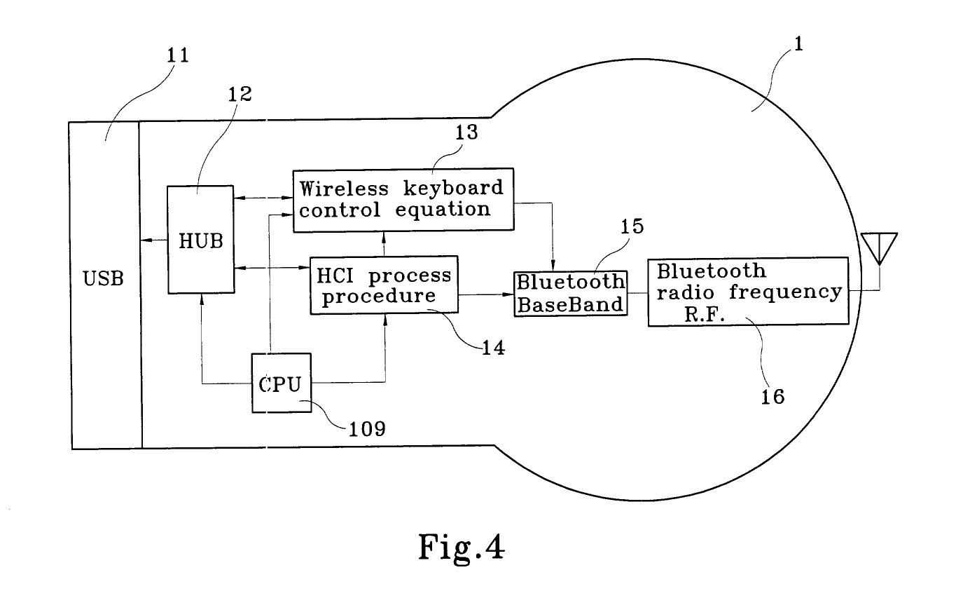

Refer to FIG. 4 for another embodiment of the invention. In this embodiment, the coordinating procedure and bluetooth protocol process program 2 is directly loaded into a chip 109 which is linked to the wireless keyboard control equation 13 and the HCI process procedure 14 to achieve the coordination control.

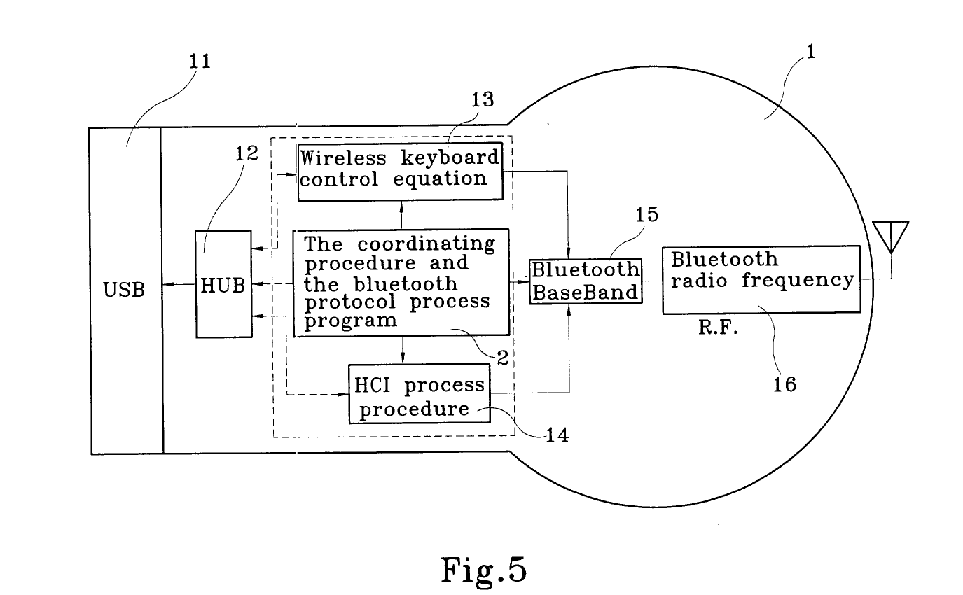

Refer to FIG. 5 for yet another embodiment of the invention. In this embodiment, the coordinating procedure and bluetooth protocol process program 2, the wireless keyboard control equation 13 and the HCI process procedure 14 are integrated in a single chip 110.

What is claimed is:

1. A method for coordinating built-in bluetooth modules that include a coordinating procedure and a bluetooth protocol process program in a bluetooth keyboard to form a wireless bluetooth module to equip with overlapped functions, comprising the steps of:
a. determining at an initial operation time whether an authentication key is depressed;
b. registering a USB keyboard module to a PC processor if the authentication key is not depressed; and
c. proceeding an authentication process, and performing hand-shaking and authentication for a keyboard transmission/receiving end if the authentication key is depressed, then registering the USB keyboard module to the PC processor.

2. The method of claim 1, wherein the authentication (identifying password) process includes registering to the computer by entering a serial number (password) by an user at the initial use time from a keyboard or by a self-setting password.

3. The method of claim 1, wherein the coordinating procedure and the bluetooth protocol process program are loaded into a single chip and linked to a HUB, a wireless keyboard control equation and a host controller interface (HCI) process procedure of a bluetooth keyboard module.

4. A method for coordinating built-in bluetooth modules that include a coordinating procedure and a bluetooth protocol process program in a bluetooth keyboard to form a wireless bluetooth module to equip with overlapped functions, comprising the steps of:
a. registering a USB keyboard module to a PC processor and processing USB Dongle/HCI registration for not initial operation;
b. determining whether having received data or commands emitted from a wireless keyboard when no keyboard commands or data are received from the USB after the USB Dongle/HCI registration processing has finished; proceeding a wireless keyboard process and control procedure when keyboard commands or data are received from the USB, then determining whether having received data or commands emitted from the wireless keyboard;
c. determining whether having received bluetooth module HCI commands or data from the USB when not receiving data or commands emitted from the wireless keyboard; proceeding a wireless keyboard function process and control procedure when having received the data or commands emitted from the wireless keyboard, then determining whether having received bluetooth module HCI commands or data from the USB;
d. determining whether having received other non-keyboard commands or data from a bluetooth base band when not receiving the bluetooth module HCI commands or data from the USB; proceeding a bluetooth module HCI process and interpretation program when having received the bluetooth module HCI commands or data from the USB, then determining whether having received other non-keyboard commands or data from the bluetooth base band; and
e. determining whether to proceed a power saving operation mode when non-keyboard commands or data were not received from the bluetooth base band; proceeding a bluetooth module HCI process program when the non-keyboard commands or data were received from the bluetooth base band, then determining whether having received the keyboard commands or data from the USB.

5. The method of claim 4, wherein the proceeding of the bluetooth module HCI process program is followed by determining whether to proceed the power saving operation mode; proceeding determination of commands and data in the event of not being the power saving operation mode; proceeding park, hold or sniff mode alteration and process for the bluetooth module base band portion in the event of being the power saving operation mode, then proceeding the determination of commands and data.

6. The method of claim 4 further including a step of entering a standby mode when the coordinating procedure and the bluetooth protocol process program receive no commands or data.

7. The method of claim 4, wherein the coordinating procedure and the bluetooth protocol process program are loaded into a single chip and linked to a HUB, a wireless keyboard control equation and a HCI process procedure of a bluetooth keyboard module.

8. The method of claim 6, wherein the coordinating procedure and the bluetooth protocol process program, the wireless keyboard control equation and the HCI process procedure are integrated in a single chip.
